(19) United States
(12) Patent Application Publication
(10) Pub. No.: US 2007/0024608 A1
(43) Pub. Date: Feb. 1, 2007

(54) Apparatus for controlling displaying images and method of doing the same

(75) Inventor: Kazuhide Sakuragi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/495,644

(22) Filed: Jul. 31, 2006

(30) Foreign Application Priority Data
Jul. 29, 2005 (JP) 2005-221421

(51) Int. Cl. G09G 5/00

(52) U.S. Cl. 345/204

(57) ABSTRACT

An apparatus for controlling displaying images to prevent a screen from being burned includes a controller which changes a display level of each of pixels constituting an image into a display level of pixels located around the each of pixels through a plurality of steps, to move a location where the image is displayed such that a distance by which an image moves in a single step is apparently smaller than a pixel. The controller moves a location at which the image is displayed such that T1 and/or T3 are(is) longer than T2, wherein each of T1, T2 and T3 indicates a length of a display period in which a display level of the each of pixels is varied by X/3, and wherein X indicates total alteration of the display level of the each of pixels, caused by moving the image by a pixel.

### BACKGROUND OF THE INVENTION

1. Field of the Invention

The invention relates to an apparatus for controlling displaying images, a method of doing the same, a program for causing a computer to carry out the method, and a display unit including the apparatus.

2. Description of the Related Art

With recent popularization of a big-size display unit, a display unit is used in various units as well as a television screen for displaying moving images.

For instance, a display unit is used for displaying a still image for a certain period of time as an advertisement display in a shop or an information display often found in a station or a service area.

It is known in the art that if images are kept displayed for a certain period of time, a screen is burned in a display unit such as a plasma display panel (PDP) and a cathode ray tube (CRT).

A screen is burned because there is a difference in degradation of a light-emitting material in a display area in which images are displayed with a brightness difference.

It is necessary to prevent a screen from being burned so as to meet various uses of a display unit. Hence, there have been suggested various solutions.

A screen saver is a typical solution for preventing a screen in a display unit from being burned. However, since if a screen saver starts working, an image displayed in a screen varies. Thus, a screen saver is not suitable to an information display.

Japanese Patent Application Publication No. 2000-227775 has suggested an apparatus for periodically moving a location at which an image is displayed, pixel by pixel in order to prevent a screen from being burned without varying an image to be displayed in the screen.

Hereinbelow is explained the image-display control carried out in the apparatus suggested in the above-mentioned Publication, with reference to FIG. 1.

FIG. 1 illustrates how locations at which images are displayed are varied in a single horizontal line with the lapse of time.

In the image-display control carried out in the apparatus suggested in the above-mentioned Publication, as illustrated in FIG. 1, locations at which images are displayed are periodically (for instance, at every display periods corresponding to four frames, as illustrated in FIG. 1) gradually moved (for instance, horizontally, as illustrated in FIG. 1) to thereby prevent a screen from being burned without changing images displayed at the screen.

However, if locations at which images are displayed are moved in such a manner as illustrated in FIG. 1, it would result in that the images entirely suddenly move by a pixel even though in a long period of time. Thus, there is caused a problem that a viewer visually feels the images unnatural.

In order to avoid such a problem, there have been suggested apparatuses or methods for moving locations at which images are displayed such that a viewer does not visually feel images unnatural, when a screen is prevented from being burned.

For instance, Japanese Patent Application Publication No. 2003-274315 suggests an apparatus which measures time in accordance with a synchronization signal of images to be displayed, and forwards or retards a phase of the synchronization signal by a predetermined period of time in accordance with the measurement result.

Japanese Patent Application Publication No. 2004-264366 suggests an apparatus which carries out pixel conversion in accordance with input signals, and set a phase between interpolated positions to be always equal to 360 degrees. The phase is varied by a degree smaller than 360 degrees. The phase is not varied when the pixel conversion is not carried out.

Similarly, Japanese Patent Application Publication No. 2005-43720 suggests an apparatus for processing an image signal by varying a phase of an interpolated position to thereby prevent non-uniformity in displayed images.

Japanese Patent Application Publication No. 2005-070226 carries out interpolation in accordance with coefficient data indicating a periodical pattern defined in accordance with a pixel-conversion ratio. A position at which coefficient data starts is set variable to thereby make it possible to shift a pixel by a distance smaller than a pixel.

Japanese Patent Application Publication No. 2005-107132 suggests an apparatus which carries out image-display control.

FIG. 2 illustrates how locations at which images are displayed are varied in a single horizontal line with the lapse of time in the apparatus suggested in the above-mentioned Publication.

Hereinbelow is explained the image-display control to be carried out in the above-mentioned Publication, with reference to FIG. 2.

In the image-display control to be carried out in the above-mentioned Publication, as illustrated in FIG. 2, locations at which images are displayed are periodically gradually moved to make it possible to prevent a screen from being burned without displayed images being changed, and images are apparently moved by a sub-pixel to make it possible to move locations at which images are displayed without a viewer visually feeling the images unnatural.

As mentioned above, the apparatus suggested in the firstly mentioned Publication is accompanied with a problem that a viewer visually feels images unnatural, because the images entirely suddenly move by a pixel.

The apparatuses suggested in the secondly to fifthly mentioned Publications which were proposed to solve the problem accompanied with the apparatus suggested in the firstly mentioned Publication are accompanied with the following problems.

In the apparatus suggested in the secondly mentioned Publication, images are smoothly moved only when input signals are analog signals. When input signals are digital signals, there is caused a problem that images are moved by a pixel. It is absolutely necessary to prevent a screen from being burned for digital input signals, because high-quality images are required presently.

The apparatus suggested in the thirdly mentioned Publication is accompanied with a problem that a pixel-conversion step and a step of moving locations at which images are displayed have to be simultaneously carried out. For instance, if locations at which images are displayed are moved beyond a pixel with a phase being smaller than 360 degrees, it would be quite difficult to read a conversion coefficient to be used when the locations move across a pixel, out of a FIFO memory. In addition, since a phase is not varied when pixel-conversion is not performed, the apparatus is accompanied further with a problem that pixel-conversion has to be performed for varying a phase.

The apparatus suggested in the fifthly mentioned Publication is accompanied with a problem that since the apparatus uses coefficient data indicating a periodical pattern defined in accordance with a pixel-conversion ratio, a resolution for a movement within a pixel varies in dependence on an expansion ratio. In addition, interpolation points adjacent to each other are not arranged in order for some pixel-conversion coefficients. Hence, the image-display control is unavoidably complicated.

The apparatus suggested in the fifthly mentioned Publication apparently moves images by a sub-pixel to thereby make it possible to move locations at which images are displayed without a viewer visually feeling the images unnatural. However, the apparatus is accompanied with a problem that images go dim.

This problem is explained in detail with reference to FIG. 3.

FIG. 3 illustrates how locations at which images are displayed vary in a single horizontal line with the lapse of time in the image-display control suggested in the fifthly mentioned Publication.

As illustrated in FIG. 3, it is assumed that pixels 1 displaying black and pixels 2 displaying white are alternately arranged in a single horizontal line in an initial condition indicated at an uppermost row.

If images are horizontally move to the right by a pixel, the pixels 2 displaying white and the pixels 1 displaying black are alternately arranged as illustrated in a lowermost row in FIG. 3.

In accordance with the display-control suggested in the fifthly mentioned Publication, when the uppermost condition in FIG. 3 is changed into the lowermost condition in FIG. 3, the pixels 1 displaying black are gradually varied into the pixels 2 displaying white with the lapse of time, and the pixels 2 displaying white are gradually varied into the pixels 1 displaying black with the lapse of time, as illustrated in FIG. 3.

Specifically, the pixel 1a located at the leftmost, the pixel 1b located at the center, and the pixel 1c located at the rightmost in the uppermost row are varied with the lapse of time as follows: the pixels 1a, 1b and 1c displaying black→pixels 3 displaying gray close to black→pixels 4 displaying gray intermediate between black and white→pixels 5 displaying gray close to white→pixels 2 displaying white.

The pixel 2a located adjacent to the pixel la and the pixel 2b located adjacent to the pixel 1c in the uppermost row are varied with the lapse of time as follows: the pixels 2a and 2b displaying white→pixels 5 displaying gray close to white→pixels 4 displaying gray intermediate between black and white→pixels 3 displaying gray close to black→pixels 1 displaying black.

In the above-mentioned step, at an intermediate point in time sequence, that is, at the third row, all of the pixels 4 display gray intermediate between black and white, resulting in that images entirely go dim.

As mentioned above, the apparatus suggested in the firstly mentioned Publication is accompanied with a problem that switching images is unnatural to a viewer, because images are moved pixel by pixel, the apparatus suggested in the secondly mentioned Publication is accompanied with a problem that the apparatus can use only analog signals, because a phase is adjusted in accordance with synchronization signals, the apparatuses suggested in the thirdly and fifthly mentioned Publications are accompanied with a problem that image-display control is quite difficult to carry out, and the apparatus suggested in the fifthly mentioned Publication is accompanied with a problem that images go dim.

### SUMMARY OF THE INVENTION

In view of the above-mentioned problems in the prior art, it is an object of the present invention to provide an apparatus for controlling displaying images, a method of doing the same, a program for causing a computer to carry out the method, and a display unit including the apparatus, all of which are capable of solving the above-mentioned problems in the prior art.

In one aspect of the present invention, there is provided an apparatus for controlling displaying images to prevent a screen from being burned by moving locations where images are displayed, including a controller which changes a display level of each of pixels constituting an image into a display level of pixels located around the each of pixels through a plurality of steps, to move a location where the image is displayed such that a distance by which an image moves in a single step is apparently smaller than a pixel, the controller moving a location at which the image is displayed such that at least one of T1 and T3 is longer than T2, wherein T1 indicates a length of a first display period in which a display level of the each of pixels is varied by X/3 from an initial display level, T2 indicates a length of a second display period in which the display level of the each of pixels is varied by X/3 from expiration of the first display period, and T3 indicates a length of a third display period in which the display level of the each of pixels is varied by X/3 from expiration of the second display period, wherein X indicates total alteration of the display level of the each of pixels, caused by moving the image by a pixel.

The controller in the apparatus in accordance with the present invention changes a display level of each of pixels constituting an image into a display level of pixels located around the each of pixels constituting an image through a plurality of steps, to move a location where the image is displayed such that an apparent distance by which an image moves in a single step is smaller than a pixel. Thus, it is possible to move a location at which an image is displayed, to avoid a viewer from visually feeling the image unnatural.

Furthermore, the controller moves a location at which an image is displayed such that at least one of T1 and T3 is longer than T2, wherein T1 indicates a length of a first display period in which a display level of the each of pixels is varied by X/3 from an initial display level, T2 indicates a length of a second display period in which the display level of the each of pixels is varied by X/3 from expiration of the first display period, and T3 indicates a length of a third display period in which the display level of the each of pixels is varied by X/3 from expiration of the second display period, wherein X indicates total alteration of the display level of the each of pixels, caused by moving the image by a pixel. Thus, it is possible to avoid an image from going dim, as explained below.

FIG. 4 illustrates image-display control to be carried out by the controller in the apparatus in accordance with the present invention. Specifically, FIG. 4 illustrates how a location at which an image is displayed moves in a single horizontal line with the lapse of time.

As illustrated in FIG. 4, it is assumed that pixels 1 displaying black and pixels 2 displaying white are alternately arranged in a single horizontal line in an initial condition indicated at an uppermost row.

If images are horizontally move to the right by a pixel, the pixels 2 displaying white and the pixels 1 displaying black are alternately arranged as illustrated in a lowermost row in FIG. 4.

The apparatus in accordance with the present invention varies the pixels 1 displaying black gradually into the pixels 2 displaying white with the lapse of time, and at the same time, varies the pixels 2 displaying white gradually into the pixels 1 displaying black with the lapse of time, as illustrated in FIG. 4, when the uppermost condition in FIG. 4 is changed into the lowermost condition in FIG. 4.

That is, a display level of each of pixels constituting an image is changed into a display level of pixels located around the each of pixels constituting an image through a plurality of steps, and thus, a location where the image is displayed is moved such that an apparent distance by which the image moves in a single step is smaller than a pixel.

Specifically, the pixel 1a located at the leftmost, the pixel 1b located at the center, and the pixel 1c located at the rightmost in the uppermost row are varied with the lapse of time as follows: the pixels 1a, 1b and 1c displaying black→pixels 3 displaying gray close to black→pixels 4 displaying gray intermediate between black and white→pixels 5 displaying gray close to white→pixels 2 displaying white.

The pixel 2a located adjacent to the pixel 1a and the pixel 2b located adjacent to the pixel 1c in the uppermost row are varied with the lapse of time as follows: the pixels 2a and 2b displaying white→pixels 5 displaying gray close to white→pixels 4 displaying gray intermediate between black and white→pixels 3 displaying gray close to black→pixels 1 displaying black.

In the above-mentioned step, at an intermediate point in time sequence, that is, at the third row in FIG. 4, all of the pixels 4 display gray intermediate between black and white, resulting in that images entirely go dim.

Thus, in the apparatus in accordance with the present invention, a length of a period of time in which the third row in FIG. 4 is maintained, that is, a length T2 of the second display period is set short, and a length T1 of the first display period and a length T3 of the third display period are set longer than a length of T1, resulting in that a period of time during which an image go dim is quite short.

Specifically, the controller moves a location at which the image is displayed such that at least one of T1 and T3 is longer than T2, wherein T1 indicates a length of a first display period in which a display level of the each of pixels is varied by X/3 from an initial display level, T2 indicates a length of a second display period in which the display level of the each of pixels is varied by X/3 from expiration of the first display period, and T3 indicates a length of a third display period in which the display level of the each of pixels is varied by X/3 from expiration of the second display period, wherein X indicates total alteration of the display level of the each of pixels, caused by moving the image by a pixel.

It is preferable that both of T1 and T3 are longer than T2 (T1>T2, T3>T2). For instance, T1 may be set longer than T2 and T3 wherein T2 is equal to T3 (T1>T2=T3), or T1 may be set equal to T2, but smaller than T3 (T1=T2<T3).

In the apparatus in accordance with the present invention, a display level of each of pixels constituting an image is changed into a display level of pixels located around the each of pixels constituting an image through a plurality of steps, and thus, a location where the image is displayed is moved such that an apparent distance by which the image moves in a single step is smaller than a pixel. Thus, it would be possible to prevent a screen from being burned even if an image is kept displayed for a certain period of time, and to smoothly move an image without causing a viewer to feel the image unnatural.

Furthermore, since the controller moves a location at which the image is displayed such that at least one of T1 and T3 is longer than T2, wherein T1 indicates a length of a first display period in which a display level of the each of pixels is varied by X/3 from an initial display level, T2 indicates a length of a second display period in which the display level of the each of pixels is varied by X/3 from expiration of the first display period, and T3 indicates a length of a third display period in which the display level of the each of pixels is varied by X/3 from expiration of the second display period, wherein X indicates total alteration of the display level of the each of pixels, caused by moving the image by a pixel, a length T2 of the second display period during which images are likely to go dim is shortened. Hence, it is possible to prevent a screen from being burned with an image being smoothly moved and without an image going dim.

It is preferable that the controller moves the image horizontally during a first period of time which is different from a second period of time during which the controller moves the image vertically.

There is further provided an apparatus for controlling displaying images to prevent a screen from being burned by moving locations where images are displayed, including a controller which changes a display level of each of pixels constituting an image into a display level of pixels located around the each of pixels through a plurality of steps, to move a location where the image is displayed such that a distance by which an image moves in a single step is apparently smaller than a pixel, the controller moving a location at which the image is displayed such that a sum of T1 and T4 is longer than a sum of T2 and T3, wherein T1 indicates a length of a first display period in which a display level of the each of pixels is varied by X/4 from an initial display level, T2 indicates a length of a second display period in which the display level of the each of pixels is varied by X/4 from expiration of the first display period, T3 indicates a length of a third display period in which the display level of the each of pixels is varied by X/4 from expiration of the second display period, and T4 indicates a length of a fourth display period in which the display level of the each of pixels is varied by X/4 from expiration of the third display period, wherein X indicates total alteration of the display level of the each of pixels, caused by moving the image by a pixel.

In the first and fourth display periods T1 and T4, an apparent position of a pixel is either identical to a position where a pixel actually exists or within a ¼ pixel around a position where a pixel actually exists, and a viewer does not recognize non-uniformity in displayed images.

In the second and third display periods T2 and T3, an apparent position of a pixel is either intermediate between two positions where two pixels actually exist or within a ¼ pixel around a center between two positions where two pixels actually exist, and a viewer can recognize non-uniformity in displayed images.

Hence, it would be possible to conceal non-uniformity in displayed images by setting a sum of T1 and T4 possibly longer than a sum of T2 and T3.

However, if both of T2 and T3 are set equal to zero, for instance, a pixel would apparently move by a half-pixel in a single step, even though non-uniformity in displayed images is concealed, and hence, a viewer could visually recognize movement of a pixel.

Conditions for a viewer not to recognize movement of a pixel and non-uniformity in displayed images are dependent on not only a size of a pixel and a distance between a viewer and a screen, but also what is displayed on a screen. If there are little intermediate gray scales and a contrast is high in a screen, the screen is likely to be burned. In such a screen, an angle of view in which a viewer can recognize movement of a pixel is generally said to be 1/120 degree.

Assuming that a distance between a viewer and a screen is twice greater than a diagonal size of a screen in a 40-size or larger screen, the distance is 2 meters. That is, when a viewer looks at a screen in 2 meters, a distance which a viewer can visually recognize when a pixel in a screen moves by a step is calculated as follows.
2000 mm×tan( 1/120)=0.29 mm

Accordingly, a viewer could not recognize apparent movement of a pixel, if a distance by which a pixel moves in a step is set equal to or smaller than a half of the calculated distance, that is, about 0.15 mm.

A pixel size in a 40-wide XGA screen (768 pixels×1365 pixels) is 0.65 mm×0.65 mm. Accordingly, it is preferable in a 40-wide XGA screen that a distance by which a pixel moves in a step is smaller than 0.15 mm, a sum of T2 and T3 is set short, and an apparent stationary position of a pixel is not a center between two pixels located adjacent thereto.

A pixel size in a 40-wide VGA screen (480 pixels×853 pixels) is 1.04 mm×1.04 mm. Accordingly, it is preferable in a 40-wide VGA screen that a distance by which a pixel moves in a step is smaller than 0.15 mm, and a sum of T2 and T3 is set short, but an apparent stationary position of a pixel may be unavoidably set close to a center between two pixels located adjacent thereto, in which case, it is preferable that a sum of T2 and T3 is set as short as possible.

There is further provided an apparatus for controlling displaying images to prevent a screen from being burned by moving locations where images are displayed, including a controller which changes a display level of each of pixels constituting an image into a display level of pixels located around the each of pixels through a plurality of steps, to move a location where the image is displayed such that a distance by which an image moves in a single step is apparently smaller than a pixel, the controller including a synthesizer which synthesizes pixels constituting an image and pixels located around the image-constituting pixels to each other, and a synthesis-ratio administrator which gradually varies a synthesis ratio in accordance with which the synthesizer synthesizes the pixels to each other, wherein a rate at which the synthesis ratio varies in at least one of first and second display periods is smaller than a rate at which the synthesis ratio varies in a second display period, wherein the first display period indicates a period in which T/3 has passed since a display level of each of pixels is an initial display level, the second display period indicates a period in which T/3 has passed since expiration of the first display period, and the third display period indicates a period in which T/3 has passed since expiration of the second display period, wherein the T indicates a time necessary for moving an image by a pixel.

There is further provided an apparatus for controlling displaying images to prevent a screen from being burned by moving locations where images are displayed, including a controller which changes a display level of each of pixels constituting an image into a display level of pixels located around the each of pixels through a plurality of steps, to move a location where the image is displayed such that a distance by which an image moves in a single step is apparently smaller than a pixel, the controller including a synthesizer which synthesizes pixels constituting an image and pixels located around the image-constituting pixels to each other, and a synthesis-ratio administrator which gradually varies a synthesis ratio in accordance with which the synthesizer synthesizes the pixels to each other, wherein a sum of a rate at which the synthesis ratio varies in a first display period and a rate at which the synthesis ratio varies in a third display period is smaller than a rate at which the synthesis ratio varies in a second display period, wherein the first display period indicates a period in which T/4 has passed since a display level of each of pixels is an initial display level, the second display period indicates a period in which T/2 has passed since expiration of the first display period, and the third display period indicates a period in which T/4 has passed since expiration of the second display period, wherein the T indicates a time necessary for moving an image by a pixel.

The first display period has a length of T/4 starting from either a time at which an apparent position of a pixel is identical with a position at which the pixel actually exists or a mid-point in a period of time during which an apparent position of a pixel is identical with a position at which the pixel actually exists, and the third display period has a length of T/4 just before the above-mentioned mid-point. In the first and third display periods, non-uniformity in displayed images is not recognized by a viewer.

The second display period is a period between the first and third display periods, that is, a period having a length of T/2 after T/4 has passed from the above-mentioned mid-point. In the second display period, a viewer can readily recognize non-uniformity in displayed images.

Accordingly, a rate at which the synthesis ratio varies is set high in the second display period in which a viewer can readily recognize non-uniformity in displayed images, whereas a rate at which the synthesis ratio varies is set low in the first and third display periods in which non-uniformity in displayed images is usually not recognized by a viewer.

It is preferable that the controller includes a step-length controller which varies a length of a time of each of the plurality of steps, wherein a length of a time in a step in at least one of the first and third display periods is longer than a length of a time in a step in the second display period.

It is preferable that the controller includes a movement-controller which varies an apparent movement-distance of an image in each step in the plurality of steps, wherein an apparent movement-distance of an image in a step in at least one of the first and third display periods is shorter than an apparent movement-distance of an image in a step in the second display period.

There is further provided an apparatus for controlling displaying images to prevent a screen from being burned by moving locations where images are displayed, including a controller which changes a display level of each of pixels constituting an image into a display level of pixels located around the each of pixels through a plurality of steps, to move a location where the image is displayed such that a distance by which an image moves in a single step is apparently smaller than a pixel, wherein an apparent average speed of the image at the time before the image moves is different from an average speed of the image at the time when the image moves by a half-pixel.

In the apparatus in accordance with the present invention, an apparent average speed of an image at the time before the image moves is different from an average speed of the image at the time when the image moves by a half-pixel. This ensures that an image can smoothly move without non-uniformity in displayed images, and a screen is prevented from being burned.

It is preferable that the apparent average speed of the image at the time before the image moves is lower than the average speed of the image at the time when the image moves by a half-pixel.

It is preferable that the controller moves the image horizontally during a first period of time which is different from a second period of time during which the controller moves the image vertically. This ensures to prevent occurrence of non-uniformity in displayed images.

It is preferable that the pixels located around each of pixels constituting an image are pixels located adjacent to the each of pixels. This ensures that a control for moving a location at which an image is displayed can be carried out by relatively simple computation.

In another aspect of the present invention, there is provided a method of controlling displaying images to prevent a screen from being burned by changing a display level of each of pixels constituting an image into a display level of pixels located around the each of pixels through a plurality of steps, to move a location where the image is displayed such that a distance by which an image moves in a single step is apparently smaller than a pixel, the method including the steps of (a) varying a display level of each of the plurality of pixels by X/3 from an initial display level, (b) varying the display level of each of the plurality of pixels by X/3 from expiration of the step (a), and (c) varying the display level of each of the plurality of pixels by X/3 from expiration of the step (b), wherein X indicates total alteration of the display level of the each of pixels, caused by moving the image by a pixel, at least one of the steps (a) and (c) being longer in length than the step (b).

The method in accordance with the present invention provides the same advantages as provided by the apparatus in accordance with the present invention.

There is further provided a method of controlling displaying images to prevent a screen from being burned by changing a display level of each of pixels constituting an image into a display level of pixels located around the each of pixels through a plurality of steps, to move a location where the image is displayed such that a distance by which an image moves in a single step is apparently smaller than a pixel, the method including the steps of (a) varying a display level of each of the plurality of pixels by a period of time T/3 from an initial display level, (b) varying the display level of each of the plurality of pixels by a period of time T/3 from expiration of the step (a), and (c) varying the display level of each of the plurality of pixels by a period of time T/3 from expiration of the step (b), wherein the T indicates a time necessary for moving an image by a pixel, wherein at least one of an apparent movement-distance of each of the plurality of pixels in the step (a) and an apparent movement-distance of each of the plurality of pixels in the step (c) is shorter than an apparent movement-distance of each of the plurality of pixels in the step (b).

In the method in accordance with the present invention, at least one of an apparent movement-distance of each of pixels in the step (a) and an apparent movement-distance of each of pixels in the step (c) is shorter than an apparent movement-distance of each of pixels in the step (b). Thus, a display level is smoothly varied in the step (b) wherein images are likely to go dim, preventing a screen from being burned.

There is further provided a method of controlling displaying images to prevent a screen from being burned by changing a display level of each of pixels constituting an image into a display level of pixels located around the each of pixels through a plurality of steps, to move a location where the image is displayed such that a distance by which an image moves in a single step is apparently smaller than a pixel, the method including the steps of (a) varying a display level of each of the plurality of pixels by a period of time T/3 from an initial display level, (b) varying the display level of each of the plurality of pixels by a period of time T/3 from expiration of the step (a), and (c) varying the display level of each of the plurality of pixels by a period of time T/3 from expiration of the step (b), wherein the T indicates a time necessary for moving an image by a pixel, wherein a rate at which a synthesis ratio varies in at least one of the steps (a) and (c) is smaller than a rate at which the synthesis ratio varies in the step (b), the synthesis-ratio being defined as a ratio in accordance with which pixels constituting the image are synthesized with pixels locate around the pixels constituting the image.

There is further provided a method of controlling displaying images to prevent a screen from being burned by changing a display level of each of pixels constituting an image into a display level of pixels located around the each of pixels through a plurality of steps, to move a location where the image is displayed such that a distance by which an image moves in a single step is apparently smaller than a pixel, the method including the step of differentiating an apparent average speed of the image at the time before the image moves from an average speed of the image at the time when the image moves by a half-pixel.

It is preferable that the apparent average speed of the image at the time before the image moves is set lower in the step than the average speed of the image at the time when the image moves by a half-pixel.

In still another aspect of the present invention, there is provided a display unit including a signal input which receives image signals, an A/D converter which converts analog image signals received at the signal input into digital image signals, an apparatus for processing the digital image signals, and a display device which display images in accordance with the digital image signals received from the apparatus, wherein the apparatus being comprised of the above-mentioned apparatus for controlling displaying image to prevent a screen from being burned by moving locations where images are displayed.

The display unit in accordance with the present invention provides the same advantages as provided by the apparatus in accordance with the present invention.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 illustrates how locations at which images are displayed are varied in a single horizontal line with the lapse of time in the conventional apparatus.

FIG. 2 illustrates how locations at which images are displayed are varied in a single horizontal line with the lapse of time in the conventional apparatus.

FIG. 3 illustrates image-display control to be carried out by the conventional apparatus.

FIG. 4 illustrates image-display control to be carried out by the controller in the apparatus in accordance with the present invention.

FIG. 5 is a block diagram of a display unit including an apparatus for controlling displaying images in accordance with the first embodiment of the present invention.

FIG. 6 is a block diagram of an example of “the controller” comprising the synthesizer and the synthesis-ratio administrator.

FIG. 7 shows a function indicating how a synthesis ratio varies with the lapse of time.

FIG. 8 illustrates a relation between movement of an image to the right and either movement of centers of gravity of pixels or alteration of a synthesis ratio.

FIG. 9 illustrates movement of center of gravity in a pixel when an image is moved to the right.

FIG. 10 illustrates an operation of the synthesizer to be carried out when an image moves to the right.

FIG. 11 illustrates a relation between movement of an image to the left and either movement of centers of gravity of pixels or alteration of a synthesis ratio.

FIG. 12 illustrates movement of center of gravity in a pixel when an image is moved to the left.

FIG. 13 illustrates an operation of the synthesizer to be carried out when an image moves to the left.

FIG. 14 shows another function indicating how a synthesis ratio varies with the lapse of time.

FIG. 15 is a block diagram of a display unit including an apparatus for controlling displaying images in accordance with the second embodiment of the present invention.

FIG. 16 illustrates an example of how a length of a time of each of steps varies with the lapse of time.

FIG. 17 illustrates another example of how a length of a time of each of steps varies with the lapse of time.

FIG. 18 illustrates still another example of how a length of a time of each of steps varies with the lapse of time.

FIG. 19 illustrates an example of movement of an image in the case that the image makes horizontal movement and vertical movement separately from each other.

FIG. 20 illustrates an example of movement of an image in the case that the image makes horizontal movement and vertical movement separately from each other.

FIG. 21 illustrates an example of movement of an image in the case that the image makes horizontal movement and vertical movement separately from each other.

FIG. 22 illustrates an example of movement of an image in the case that the image makes horizontal movement and vertical movement separately from each other.

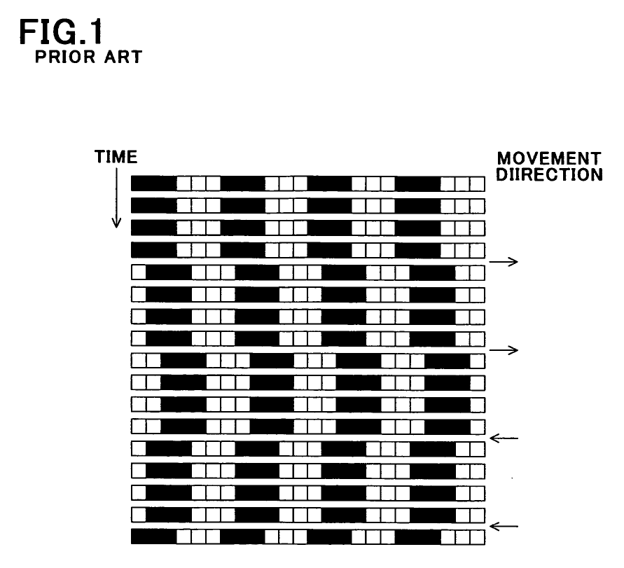

### DESCRIPTION OF THE PREFERRED EMBODIMENTS

Preferred embodiments in accordance with the present invention will be explained hereinbelow with reference to drawings.

### First Embodiment

In the apparatus in accordance with the first embodiment of the present invention, a location at which an image is displayed is moved by a pixel in a certain number of steps (for instance, 256 steps) in a certain period of time (for instance, 60 seconds). During the location is moved, a length of a time in each of the steps is kept constant (for instance, 60/256 seconds), but a synthesis ratio by which pixels constituting an image and pixels located adjacent to the pixels constituting an image are synthesized to each other is varied with the lapse of time.

Specifically, a rate at which the synthesis ratio is varied is set relatively small in the first and third display periods, and the rate is set relatively high in the second display period in which an image is likely to go dim, to thereby set a length T1 of the first display period longer than a length T2 of the second display period, and further set a length T3 of the third display period longer than a length T2 of the second display period.

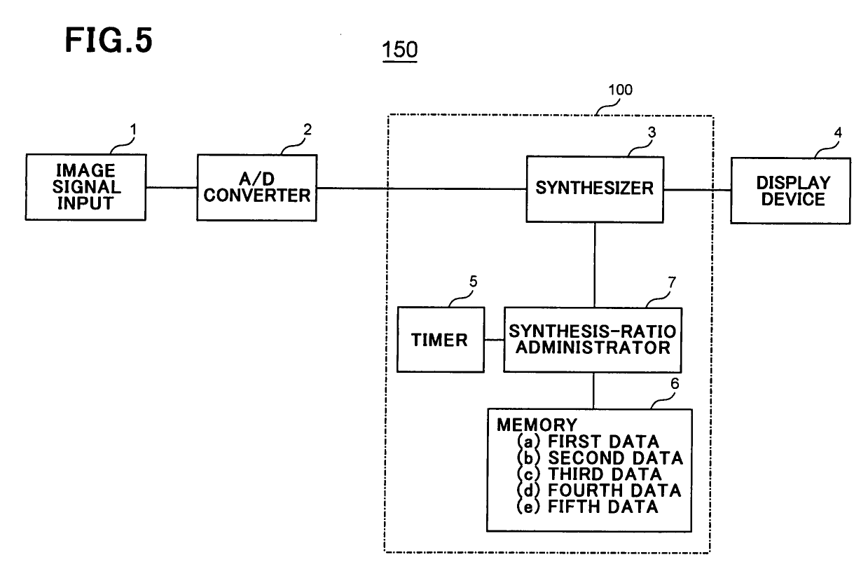

FIG. 5 is a block diagram of a display unit 150 including an apparatus 100 for controlling displaying images in accordance with the first embodiment of the present invention.

As illustrated in FIG. 5, the display unit 150 is comprised of an image signal input 1 which receives image signals, an A/D converter 2 which converts analog image signals received at the image signal input 1 into digital image signals, an apparatus 100 for controlling displaying images which applies later-mentioned process to the digital image signals, and a display device 4 which display images in accordance with the digital image signals received from the apparatus 100.

For instance, the display unit 150 is comprised of a plasma display unit, in which case, the display device 4 is comprised of a plasma display panel.

Specifically, the apparatus 100 includes a synthesizer 3 which synthesizes image signals corresponding to pixels constituting an image and image signals corresponding to pixels located adjacent to the pixels constituting an image to each other, and outputs the synthesized image signals to the display device 4, a synthesis-ratio administrator 7 which calculates a rate in accordance with which the synthesizer 3 synthesizes the image signals to each other, and provides the calculated synthesis-ratio to the synthesizer 3, a memory 6 storing data used for calculating a synthesis-ratio in the synthesis-ratio administrator 7, and a timer 5 which measures a time, and outputs the measurement result to the synthesis-ratio administrator 7.

The synthesizer 3 and the synthesis-ratio administrator 7 define “a controller” in claims.

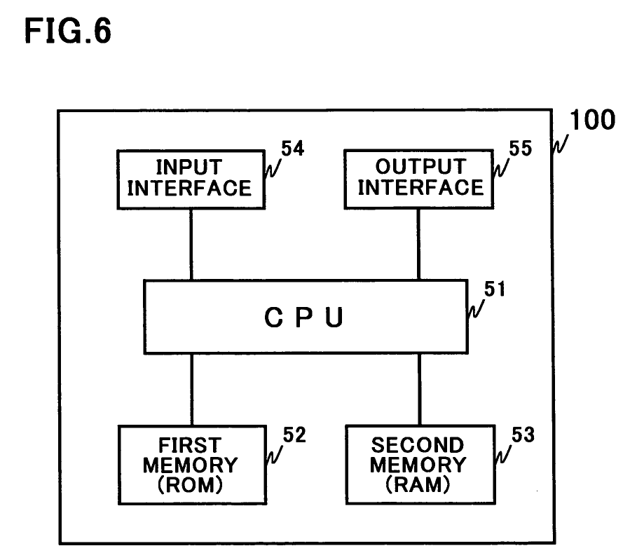

FIG. 6 is a block diagram of an example of “the controller” comprising the synthesizer 3 and the synthesis-ratio administrator 7.

As illustrated in FIG. 6, “the controller” is comprised of a central processing unit (CPU) 51, a first memory 52, a second memory 53, an input interface 54 through which a command and/or data is input into the central processing unit 51, and an output interface 55 through which a result of steps having been executed by the central processing unit 51 is output.

Each of the first and second memories 52 and 53 is comprised of a semiconductor memory such as a read only memory (ROM), a random access memory (RAM) or an IC memory card, or a storage device such as a flexible disc, a hard disc or an optic magnetic disc.

In the first embodiment, the first memory 52 comprises a read only memory (ROM), and the second memory 53 comprises a random access memory (RAM).

The first memory 52 stores therein a program for causing a computer to carry out a method of controlling displaying images to prevent a screen from being burned by changing a display level of each of pixels constituting an image into a display level of pixels located around the each of pixels through a plurality of steps, to move a location where the image is displayed such that a distance by which an image moves in a single step is apparently smaller than a pixel. The second memory 53 stores therein various data and parameters, and presents a working area to the central processing unit 51. The central processing unit 51 reads the program out of the first memory 52, and executes the program. Thus, the central processing unit 51 operates in accordance with the program stored in the first memory 52.

Image signals such as composite signals, component signals and RGB signals are processed in the image signal input 1. For instance, input-switching, color separation and color demodulation are applied to the image signals.

Thereafter, the image signals are converted into digital signals from analog signals in the A/D converter 2.

The digital image signals are transmitted to the synthesizer 3 of the apparatus 100.

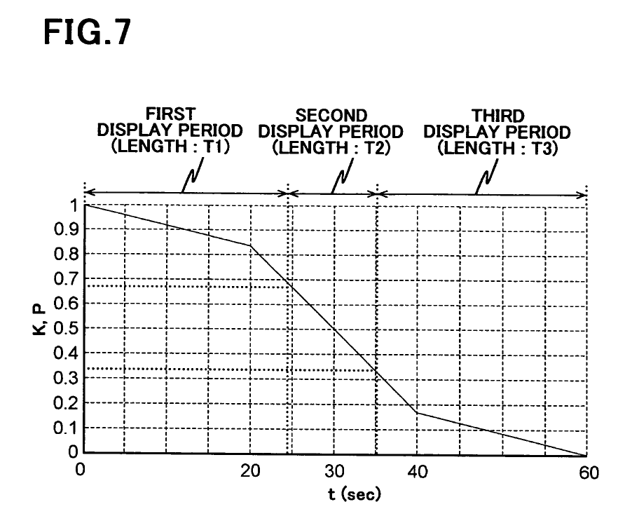

The memory 6 stores therein first data indicative of a length of a time necessary for moving an image by a pixel (for instance, 60 seconds), second data indicative of a number of steps necessary for moving an image by a pixel (for instance, 256 steps), third data indicative of a length of a time of each of the steps (for instance, 60/256 seconds), fourth data indicative of a direction in which an image moves for each time, and fifth data indicative of a function (for instance, see FIG. 7) used for calculating a synthesis ratio in the synthesis-ratio administrator 7. The synthesis-ratio administrator 7 reads requisite data out of the memory 6.

The synthesis-ratio administrator 7 calculates centers of gravity of both pixels constituting an image and pixels located adjacent to the pixels constituting an image as a synthesis ratio. The synthesis-ratio administrator 7 transmits the thus calculated synthesis ratio to the synthesizer 3.

It is assumed in the first embodiment that an image is horizontally moved in reciprocation. Specifically, one cycle of movement of an image comprising reciprocating movement of 32 pixels, that is, movement of a predetermined number of pixels (for instance, 8 pixels) to the right, movement of the predetermined number of pixels to the left, movement of the predetermined number of pixels to the left, and movement of the predetermined number of pixels to the right is repeatedly carried out.

Accordingly, in each of cycles, an image moves to the right during the first 480 seconds (60 seconds per a pixel×8 pixels), to the left during the next 960 seconds (60 seconds per a pixel×16 pixels), and further, to the right during the next 480 seconds (60 seconds per a pixel×8 pixels).

The fourth data stored in the memory 6 indicates a direction in which an image moves. Specifically, the fourth data indicates “right” or “left”.

The synthesis-ratio administrator 7 recognizes a direction in which an image currently moves, based on the fourth data read out of the memory 6 and the time data transmitted from the timer 5.

For instance, if the synthesis-ratio administrator 7 recognizes that 100 seconds have passed after an image has started moving in a cycle, based on the time data transmitted from the timer 5, the synthesis-ratio administrator 7 can know that the image currently moves to the right. Similarly, if the synthesis-ratio administrator 7 recognizes that 500 seconds have passed after an image has started moving in a cycle, based on the time data transmitted from the timer 5, the synthesis-ratio administrator 7 can know that the image currently moves to the left.

The synthesis-ratio administrator 7, each time a step is switched, newly calculates a current synthesis ratio of pixels constituting an image and pixels located adjacent to the pixels constituting an image in a step for moving an image by a pixel.

The synthesis-ratio administrator 7 in the first embodiment can know how many steps have been carried out, based on the third data (for instance, 60/256 seconds) read out of the memory and the time data transmitted from the timer 5.

For instance, if the synthesis-ratio administrator 7 recognizes that a time having passed after an image started moving by a pixel is equal to or greater than 120/256 seconds, but smaller than 180/256 seconds, based on the time data transmitted from the timer 5, the synthesis-ratio administrator 7 could know that a current step is the second step.

As an alternative, the synthesis-ratio administrator 7 can recognize how many steps have been carried out by counting how many times a synthesis ratio were calculated in a step during which an image is moved by a pixel.

For instance, the synthesis-ratio administrator 7 calculates a synthesis ratio through the use of the function shown in FIG. 7, and transmits the calculated synthesis ratio to the synthesizer 3.

The synthesizer 3 adjusts levels of both pixels constituting an image and pixels located adjacent thereto in accordance with a synthesis ratio received from the synthesis-ratio administrator 7. Herein, the synthesis ratio indicates a position of center of gravity. Thus, the synthesizer 3 moves centers of gravity in those pixels, and transmits image signals associated with the pixels to the display device 4.

The display device 4 displays images in accordance with the image signals received from the synthesizer 3.

Accordingly, each time a step is switched, display levels in each of the pixels are varied.

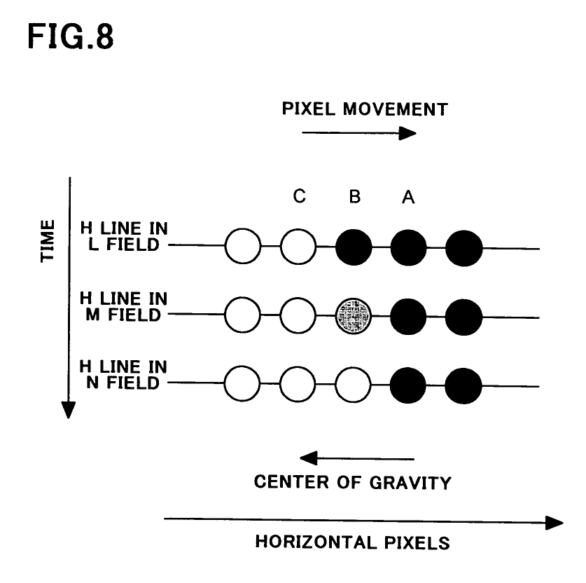

Hereinbelow is explained an operation of the apparatus 100 to be carried out when an image is moved to the right, with reference to FIGS. 8 to 10.

FIG. 8 illustrates a relation between movement of an image and either movement of centers of gravity of pixels or alteration of a synthesis ratio.

As illustrated in FIG. 8, it is assumed that a reference pixel in a horizontal line H is labeled “B”, a pixel located to the right of the reference pixel B is labeled “A”, and a pixel located to the left of the reference pixel B is labeled “C”. FIG. 8 illustrates an image displayed at the pixel B moves to the pixel A over a field L to a field N with the lapse of time.

Looking at the pixel B, it is understood that a display level of the pixel B of the field L is gradually turning at a field M to a display level of the pixel C of the field L, and completely turns at a field N to a display level of the pixel C of the field L.

That is, when a viewer can visually recognize that an image displayed at the pixel B moves to the pixel A with the lapse of time, it can be said that a display level of the pixel B is turned to a display level of the pixel C.

Hereinafter, phenomenon that a display level of the pixel B is turned to a display level of the pixel C is called movement of center of gravity from the pixel B to the pixel C.

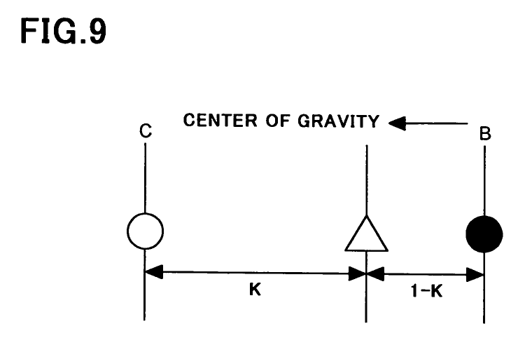

As illustrated in FIG. 9, a rate of movement of center of gravity calculated by the synthesis-ratio administrator 7 is expressed as “K” and “1−K” (0≦K=1).

The rate K gradually turns from zero (0) to one (1) as the center of gravity moves (or the synthesis ratio varies) in each of steps included in a process during which an image moves by a pixel, as illustrated in FIG. 7 and 9.

In FIG. 8, the rate K of the pixel B in a field L is equal to one (K=1), and the rate K of the pixel B in a field N is equal to zero (K=0).

The rate K has a resolution equal to a figure defined as the second data (for instance, 256).

FIG. 7 shows a function indicating how the rate K varies with the lapse of time. In FIG. 7, the axis of ordinates indicates the rate K, and the axis of abscissa indicates lapse of time T in a process during which an image moves by a pixel.

For instance, it is assumed that a period of time (for instance, 60 seconds) necessary for an image to move by a pixel is divided into three time sections, namely, a first time section (first 20 seconds), a second time section (next 20 seconds), and a third time section (final 20 seconds). The function has an inclination an absolute value of which is relatively small in the first and third time sections, and an inclination an absolute value of which is relatively high in the second time section.

The synthesis-ratio administrator 7, each time it recognizes that a step is switched, based on both the third data read out of the memory and the time data received from the timer 5, calculates the rates “K” and “1−K” in each of steps in accordance with the fifth data (namely, data indicating such a function as illustrated in FIG. 7) read out of the memory 6. The thus calculated “K” and “1−K” are transmitted to the synthesizer 3.

The synthesizer 3 synthesizes images signals corresponding to the pixel B and image signals corresponding to the pixel C to each other in accordance with the rates “K” and “1−K” to thereby calculate an image signal associated with a new pixel B.

A level of the new pixel B obtained by synthesizing the pixels B and C to each other is defined as follows.
K×(level of the pixel B)+(1−K)×(level of the pixel C)

That is, the synthesis-ratio administrator 7 gradually varies a synthesis ratio in accordance with which the synthesizer 3 synthesizes pixels to each other.

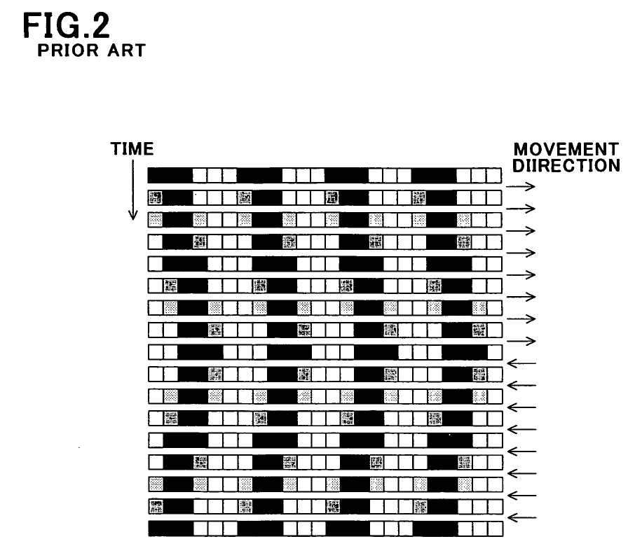

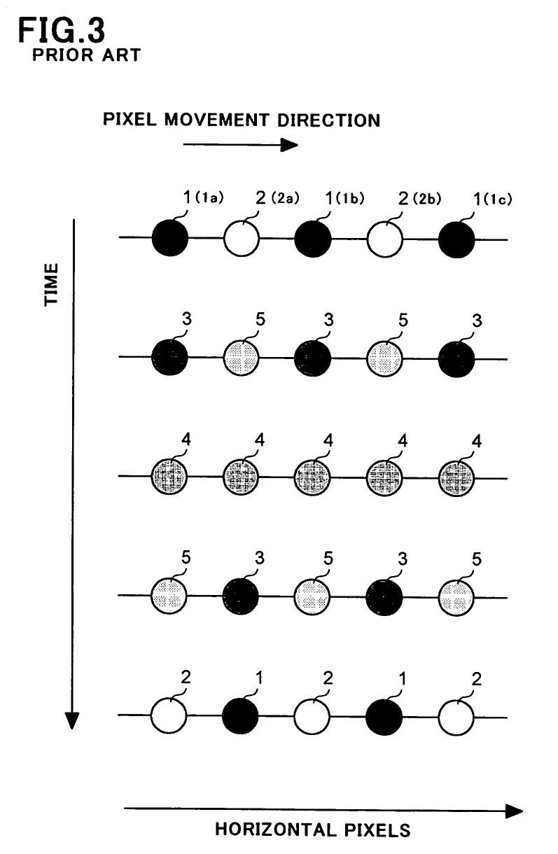

Thus, as illustrated in FIG. 2, for instance, it is possible to move a location at which an image is displayed such that a distance by which the image moves in a single step is apparently smaller than a pixel, by changing a display level of each of pixels constituting an image into a display level of pixels located therearound through a plurality of steps.

Herein, it is assumed for simplification that, in a process during which an image moves by a pixel, the rate K is in the range of 1 to 2/3 in a first display period, the rate K is in the range of 2/3 to 1/3 in a second display period, and the rate K is in the range of 1/3 to 0 in a third display period.

That is, assuming that X indicates total alteration of a display level of each of pixels, caused by moving an image by a pixel, the first display period indicates a period in which a display level of each of pixels is varied by X/3 from an initial display level, the second display period indicates a period in which a display level of each of pixels is varied by X/3 from expiration of the first display period, and the third display period indicates a period in which a display level of each of pixels is varied by X/3 from expiration of the second display period.

Hence, an image is relatively clear in the first and third display periods, whereas an image is likely to go dim in the second display period.

As illustrated in FIG. 7, since an average absolute value of the inclination of the function indicating how the rate K varies with the lapse of time is relatively small in the first and third display periods, an average rate at which a synthesis ratio varies is relatively small.

In contrast, since an average absolute value of the inclination of the function indicating how the rate K varies with the lapse of time is relatively high in the second display period, a rate at which a synthesis ratio varies is relatively high.

Accordingly, as illustrated in FIG. 7, a length T1 of the first display period is longer than a length T2 of the second display period (T1>T2), and a length T3 of the third display period is longer than a length T2 of the second display period (T3>T2).

Thus, since it is possible to shorten a length T2 of the second display period during which an image is likely to go dim, it is possible to avoid an image from going dim in an entire step during which an image moves by a pixel.

In other words, since an apparent average speed of an image at the time before the image moves (which is included in the first display period) is smaller than an average speed of the image at the time when the image moves by a half-pixel (which is included in the second display period), it is possible to avoid an image from going dim. Herein, “the time before the image moves” does not mean a time at which an image is stationary, but means a time at which an image is moving, such as a time at which an image has already moved by a pixel in a process during which the image continuously horizontally moves by eight pixels.

The function indicating how the rate K varies with the lapse of time is expressed, for instance, as “K=−(T/120)+1” in the first display period, “K=−(T/30)+3/2” in the second display period, and “K=−(T/120)+1/2” in the third display period, as illustrated in FIG. 7.

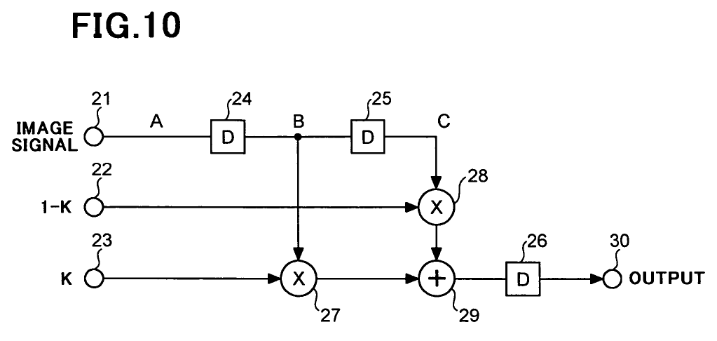

FIG. 10 illustrates an operation of the synthesizer 3 to be carried out when an image moves to the right.

As illustrated in FIG. 10, the synthesizer 3 is comprised of a first input terminal 21 through which an image signal is input from the A/D converter 2, a second input terminal 22 through which a coefficient “1−K” is input from the synthesis-ratio administrator 7, a third input terminal 23 through which a coefficient “K” is input from the synthesis-ratio administrator 7, a first D flip-flop 24, a second D flip-flop 25, a third D flip-flop 26, a first multiplier 27, a second multiplier 28, an adder 29, and an output terminal 30 through which an image signal is output to the display device 4.

Herein, a pixel corresponding to an image signal input through the first input terminal 21 and passing through the first D flip-flop 24 is labeled “pixel B”, and a pixel corresponding to an image signal passing through the second D flip-flop 25 is labeled “pixel C”. The image signal corresponding to the pixel B is input into the first multiplier 27, and the image signal corresponding to the pixel C is input into the second multiplier 28.

The coefficient K and the image signal corresponding to the pixel B are multiplied to each other in the first multiplier 27, and the coefficient (1−K) and the image signal corresponding to the pixel C are multiplied to each other in the second multiplier 28.

An output transmitted from the first multiplier 27 and an output transmitted from the second multiplier 28 are input into the adder 29, and added to each other in the adder 29. An output transmitted from the adder 29 passes through the third D flip-flop 26, and then, output through the output terminal 30.

As mentioned above, center of gravity is moved from the pixel B to the pixel C located adjacent to the pixel B in a predetermined period of time (for instance, 60 seconds) by gradually changing a display level of the pixel B to a display level of the pixel C through the use of the coefficients “K” and “1−K” indicative of a ratio of center of gravity between the pixel B and the pixel C towards which the center of gravity moves.

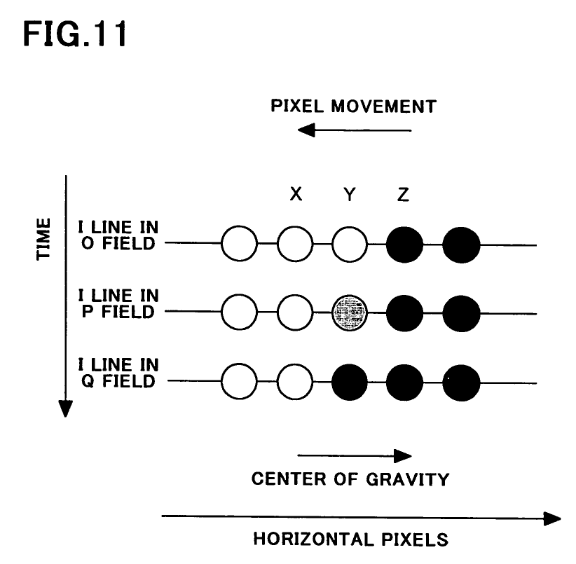

An operation of the synthesizer 3 to be carried out when an image moves to the left is explained hereinbelow with reference to FIGS. 11 to 13.

FIG. 11 illustrates a relation between movement of an image to the left and either movement of centers of gravity of pixels or alteration of a synthesis ratio.

As illustrated in FIG. 11, it is assumed that a reference pixel in a horizontal line I is labeled “Y”, a pixel located to the right of the reference pixel Y is labeled “Z”, and a pixel located to the left of the reference pixel Y is labeled “X”. FIG. 11 illustrates an image displayed at the pixel Y moves to the pixel Z over a field O to a field Q with the lapse of time.

Looking at the pixel Y, it is understood that a display level of the pixel Y of the field O is gradually turning at a field P to a display level of the pixel Z of the field O, and completely turns at a field Q to a display level of the pixel Z of the field O.

That is, when a viewer can visually recognize that an image displayed at the pixel Y moves to the pixel Z with the lapse of time, it can be said that a display level of the pixel Y is turned to a display level of the pixel Z.

Hereinafter, phenomenon that a display level of the pixel Y is turned to a display level of the pixel Z is called movement of center of gravity from the pixel Y to the pixel Z.

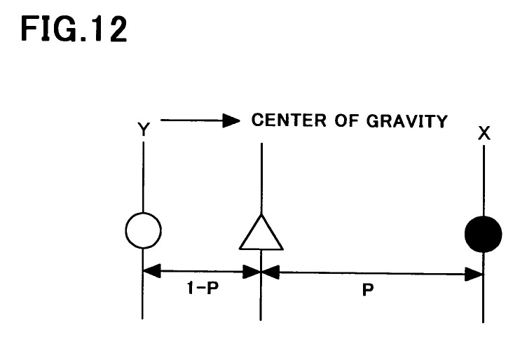

As illustrated in FIG. 12, a rate of movement of center of gravity calculated by the synthesis-ratio administrator 7 is expressed as “P” and “1−P” (0≦K≦1).

The rate P gradually turns from one (1) to zero (0) as the center of gravity moves (or the synthesis ratio varies) in each of steps included in a process during which an image moves by a pixel, as illustrated in FIG. 7 and 12.

In FIG. 11, the rate P of the pixel Y in a field O is equal to one (P=1), and the rate P of the pixel Y in a field Q is equal to zero (P=0).

The rate P has a resolution equal to a figure defined as the second data (for instance, 256).

As illustrated in FIG. 7, for instance, a function indicating how the rate P varies with the lapse of time is identical with the function indicating how the rate K varies with the lapse of time.

As mentioned earlier, the synthesis-ratio administrator 7, each time it recognizes that a step is switched, based on both the third data read out of the memory and the time data received from the timer 5, calculates the rates “P” and “1−P” in each of steps in accordance with the fifth data (namely, data indicating such a function as illustrated in FIG. 7) read out of the memory 6. The thus calculated “P” and “1−P” are transmitted to the synthesizer 3.

The synthesizer 3 synthesizes images signals corresponding to the pixel Y and image signals corresponding to the pixel X to each other in accordance with the rates “P” and “1−P” to thereby calculate an image signal associated with a new pixel Y.

A level of the new pixel Y obtained by synthesizing the pixels Y and X to each other is defined as follows.
P×(level of the pixel Y)+(1−P)×(level of the pixel X)

That is, the synthesis-ratio administrator 7 gradually varies a synthesis ratio in accordance with which the synthesizer 3 synthesizes pixels to each other.

When an image moves to the left, as illustrated in FIG. 7, a length T1 of the first display period is longer than a length T2 of the second display period (T1>T2), and a length T3 of the third display period is longer than a length T2 of the second display period (T3>T2).

Thus, since it is possible to shorten a length T2 of the second display period during which an image is likely to go dim, it is possible to avoid an image from going dim in an entire step during which an image moves by a pixel.

FIG. 12 illustrates an operation of the synthesizer 3 to be carried out when an image moves to the left.

As illustrated in FIG. 12, the synthesizer 3 is comprised of a first input terminal 31 through which an image signal is input from the A/D converter 2, a second input terminal 32 through which a coefficient “P” is input from the synthesis-ratio administrator 7, a third input terminal 33 through which a coefficient “1−P” is input from the synthesis-ratio administrator 7, a first D flip-flop 34, a second D flip-flop 35, a third D flip-flop 36, a first multiplier 37, a second multiplier 38, an adder 39, and an output terminal 40 through which an image signal is output to the display device 4.

Herein, a pixel corresponding to an image signal input through the first input terminal 31 is labeled “X”, and a pixel corresponding to an image signal passing through the first D flip-flop 34 is labeled “Y”. The image signal corresponding to the pixel X is input into the first multiplier 37, and the image signal corresponding to the pixel Y is input into the second multiplier 38.

The coefficient (1−P) and the image signal corresponding to the pixel X are multiplied to each other in the first multiplier 37, and the coefficient P and the image signal corresponding to the pixel Y are multiplied to each other in the second multiplier 38.

An output transmitted from the first multiplier 37 and an output transmitted from the second multiplier 38 are input into the adder 39, and added to each other in the adder 39. An output transmitted from the adder 39 passes through the third D flip-flop 36, and then, output through the output terminal 40.

As mentioned above, center of gravity is moved from the pixel Y to the pixel X located adjacent to the pixel Y in a predetermined period of time (for instance, 60 seconds) by gradually changing a display level of the pixel Y to a display level of the pixel X through the use of the coefficients “P” and “1−P” indicative of a ratio of center of gravity between the pixel Y and the pixel X towards which the center of gravity moves.

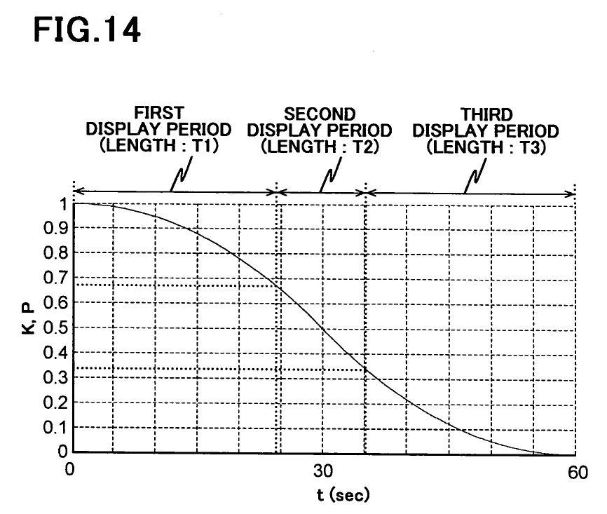

In the first embodiment, a synthesis-ratio is calculated through the use of a graph comprised of a plurality of linear sections as illustrated in FIG. 7. However, it is more preferable to use a graph comprised of a curve as illustrated in FIG. 14.

In the function illustrated in FIG. 14, the axis of ordinates indicates the rates K and P, and the axis of abscissa indicates lapse of time T in a process during which an image moves by a pixel.

For instance, it is assumed that a period of time (for instance, 60 seconds) necessary for an image to move by a pixel is divided into two time sections, namely, a first time section (first 30 seconds) and a second time section (next 30 seconds).

In the first time section, the curve is expressed as follows.
K=−(T²/1800)+1

In the second time section, the curve is expressed as follows.
K=(T−60)²/1800

Herein, it is assumed for simplification that, in a process during which an image moves by a pixel, the rates K and P are in the range of 1 to 2/3 in a first display period, the rates K and P are in the range of 2/3 to 1/3 in a second display period, and the rates K and P are in the range of 1/3 to 0 in a third display period.

Since an absolute value of an inclination of the function, indicative of how K and P vary with the lapse of time, is relatively small in the first and third display periods, a rate at which the synthesis ratio varies is relatively small. Since an absolute value of an inclination of the function, indicative of how K and P vary with the lapse of time, is relatively high in the second display period, a rate at which the synthesis ratio varies is relatively high.

Accordingly, as illustrated in FIG. 14, a length T1 of the first display period is longer than a length T2 of the second display period (T1>T2), and a length T3 of the third display period is longer than a length T2 of the second display period (T3>T2).

Thus, since it is possible to shorten a length T2 of the second display period during which an image is likely to go dim, it is possible to avoid an image from going dim in an entire step during which an image moves by a pixel.

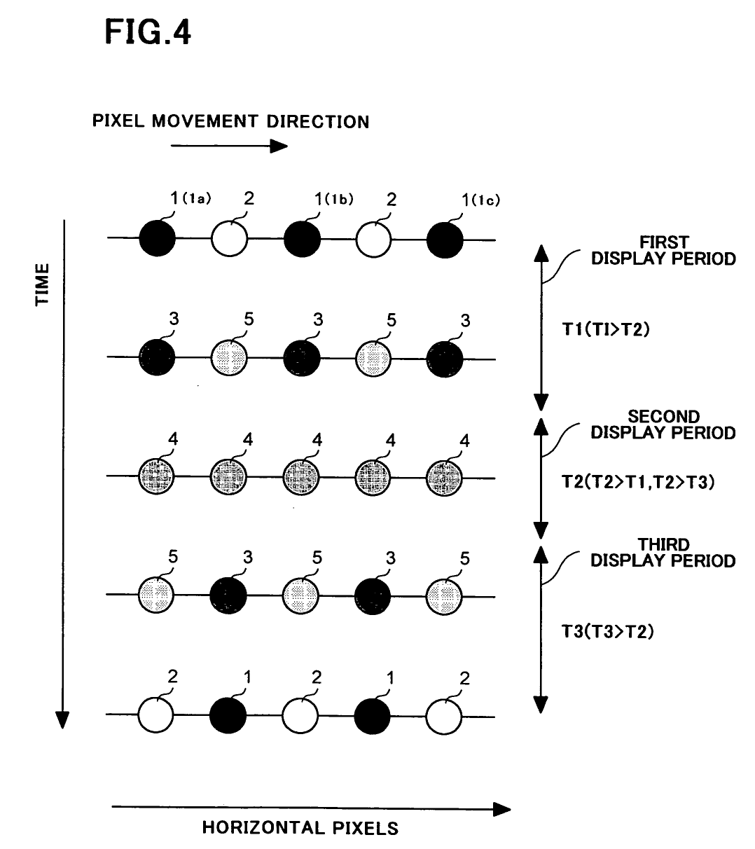

As having been explained so far, in the apparatus 100 in accordance with the first embodiment, as illustrated in FIG. 4, for instance, a location where an image is displayed is moved such that a distance by which an image moves in a single step is apparently smaller than a pixel, by changing a display level of each of pixels constituting an image into a display level of pixels located adjacent thereto through a plurality of steps. Accordingly, it is possible to prevent a screen from being burned even if an image is kept displayed for a certain period of time, and further, to smoothly move an image without a viewer visually feeling unnatural.

Furthermore, in the apparatus 100 in accordance with the first embodiment, since the controller comprised of the synthesizer 3 and the synthesis-ratio administrator 7 moves a location at which the image is displayed such that at least one of T1 and T3 is longer than T2, wherein T1 indicates a length of a first display period in which a display level of the each of pixels is varied by X/3 from an initial display level, T2 indicates a length of a second display period in which the display level of the each of pixels is varied by X/3 from expiration of the first display period, and T3 indicates a length of a third display period in which the display level of the each of pixels is varied by X/3 from expiration of the second display period, wherein X indicates total alteration of the display level of the each of pixels, caused by moving the image by a pixel, a length T2 of the second display period during which images are likely to go dim is shortened. Hence, it is possible to prevent a screen from being burned with an image being smoothly moved and without an image going dim.

In the apparatus 100 in accordance with the first embodiment, a rate at which the synthesis ratio varies in at least one of first and second display periods is smaller than a rate at which the synthesis ratio varies in a second display period, wherein the first display period indicates a period in which T/3 has passed since a display level of each of pixels is an initial display level, the second display period indicates a period in which T/3 has passed since expiration of the first display period, and the third display period indicates a period in which T/3 has passed since expiration of the second display period, wherein the T indicates a time necessary for moving an image by a pixel. Thus, a rate at which the synthesis rate varies in the second display period during which an image is likely to go dim can be set high. Hence, it is possible to prevent a screen from being burned with an image being smoothly moved and without an image going dim.

Furthermore, since an apparent average speed of an image at the time before the image moves is different from an average speed of the image at the time when the image moves by a half-pixel in a process during which the image moves by a pixel, it is possible to prevent a screen from being burned with an image being smoothly moved and without an image going dim.

The first embodiment may be expressed as a method of controlling displaying images to prevent a screen from being burned by changing a display level of each of pixels constituting an image into a display level of pixels located around the each of pixels through a plurality of steps, to move a location where the image is displayed such that a distance by which an image moves in a single step is apparently smaller than a pixel. The method includes the steps of (a) varying a display level of each of the plurality of pixels by a period of time T/3 from an initial display level, (b) varying the display level of each of the plurality of pixels by a period of time T/3 from expiration of the step (a), and (c) varying the display level of each of the plurality of pixels by a period of time T/3 from expiration of the step (b), wherein T indicates a time necessary for moving an image by a pixel. At least one of an apparent movement-distance of each of the plurality of pixels in the step (a) and an apparent movement-distance of each of the plurality of pixels in the step (c) is shorter than an apparent movement-distance of each of the plurality of pixels in the step (b). Hence, it is possible to prevent a screen from being burned with an image being smoothly moved and without an image going dim.

### Second Embodiment

In the above-mentioned first embodiment, in a process during which an image is moved by a pixel in a predetermined number of steps (for instance, 256 steps) in a predetermined period of time (for instance, 60 seconds), each of the steps has a constant time length (for instance, 60/256 seconds), but a rate at which pixels constituting an image and pixels located adjacent thereto are synthesized to each other varies with the lapse of time, as illustrated in FIGS. 7 and 14.

In the second embodiment explained hereinbelow, a rate at which pixels constituting an image and pixels located adjacent thereto are synthesized to each other is kept constant, but each of the steps has a varying time length.

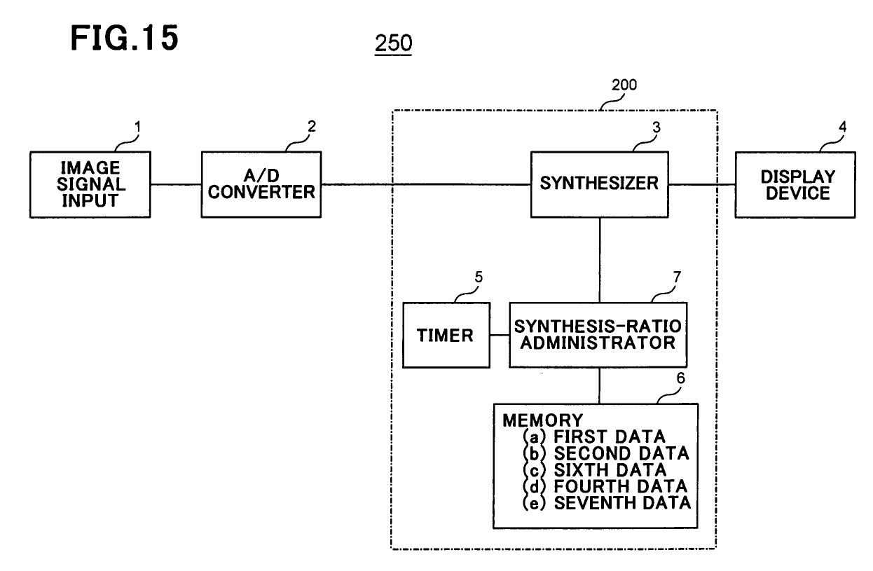

FIG. 15 is a block diagram of a display unit 250 including an apparatus 200 for controlling displaying images in accordance with the second embodiment.

The display unit 250 illustrated in FIG. 15 is different from the display unit 150 illustrated in FIG. 5 only in both an operation of the synthesis-ratio administrator 7 and what is stored in the memory 6, and has the same structure as that of the display unit 150 illustrated in FIG. 5 except those. Accordingly, parts or elements that correspond to those of the display unit 150 have been provided with the same reference numerals, and operate in the same manner as corresponding parts or elements in the display unit 150, unless explicitly explained hereinbelow.

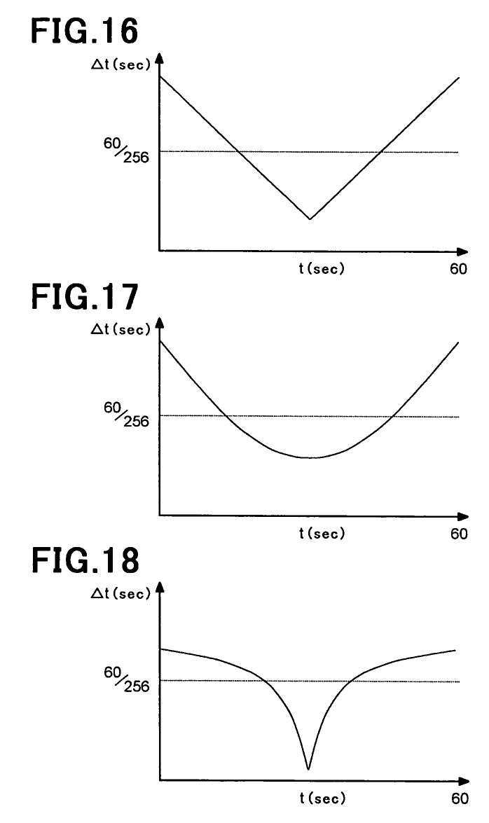

The memory 6 stores therein first data indicative of a length of a time necessary for moving an image by a pixel (for instance, 60 seconds), second data indicative of a number of steps necessary for moving an image by a pixel (for instance, 256 steps), sixth data indicative of a function (see FIG. 16) used for calculating a length of a time of each of steps, fourth data indicative of a direction in which an image moves for each time, and seventh data indicative of a rate at which a synthesis ratio varies each time a step is switched, that is, a rate at which coefficients K and P vary. The synthesis-ratio administrator 7 reads requisite data out of the memory 6.

In the second embodiment, the synthesis-ratio administrator 7 recognizes how many steps have been carried out, by counting how many times a synthesis ratio has been calculated in a process during which an image moves by a pixel.

In the second embodiment, the seventh data indicates a constant, for instance, 1/256. Hence, in the second embodiment, each time a step is switched, the coefficients K and P decrease by 1/256, gradually turning to zero (0) from one (1).

In the second embodiment, the synthesis-ratio administrator 7 calculates a length of a time of each of steps included in a process during which an image is moved by a pixel, based on the sixth data read out of the memory 6. For instance, the sixth data is indicative of a function expressed as a curve illustrated in FIG. 16.

That is, the synthesis-ratio administrator 7 varies a length of a time of each of a plurality of steps included in a process during which an image is moved by a pixel. In other words, the synthesis-ratio administrator 7 acts as a step-length controller.

The synthesis-ratio administrator 7 calculates a length of a time of each of the steps each time a step is switched, based on the sixth data, resulting in that a length of a time of each of the steps (At) is relatively long in a first 1/3 period in a process during which an image is moved by a pixel, relatively short in a second 1/3 period in the process, and relatively long in a third 1/3 period in the process.

Herein, assuming for simplification that, in a process during which an image moves by a pixel, the rates K and P are in the range of 1 to 2/3 in a first display period, the rates K and P are in the range of 2/3 to 1/3 in a second display period, and the rates K and P are in the range of 1/3 to 0 in a third display period, the synthesis-ratio administrator 7 sets a length of a time of each of the steps relatively long in the first and third display periods, and relatively short in the second display period.

In other words, assuming that X indicates total alteration of a display level of the each of pixels, caused by moving an image by a pixel, T1 indicates a length of a first display period in which a display level of the each of pixels is varied by X/3 from an initial display level, T2 indicates a length of a second display period in which the display level of the each of pixels is varied by X/3 from expiration of the first display period, and T3 indicates a length of a third display period in which the display level of the each of pixels is varied by X/3 from expiration of the second display period, a length of a time of each of steps is set relatively long in the first and third display periods, and a length of a time of each of steps is set relatively short in the second display period.

Accordingly, it is possible in the second embodiment to move an image such that a length T1 of the first display period is longer than a length T2 of the second display period (T1>T2), and a length T3 of the third display period is longer than a length T2 of the second display period (T3>T2).

Hence, it is possible to shorten a length T2 of the second display period in which an image is likely to go dim, and to prevent an image from going dim entirely in a process during which an image is moved by a pixel.

In the calculation of a length of a time of each of steps, as illustrated in FIG. 16, a length of a time of each of steps linearly varies with the lapse of time. As an alternative, a length of a time of each of steps may vary in accordance with curves illustrated in FIGS. 17 and 18.

The apparatus 200 in accordance with the second embodiment provides the same advantages as those provided by the apparatus 100 in accordance with the first embodiment.

In the above-mentioned first and second embodiments, an image is moved horizontally in reciprocation. As an alternative, an image may be moved vertically or obliquely.

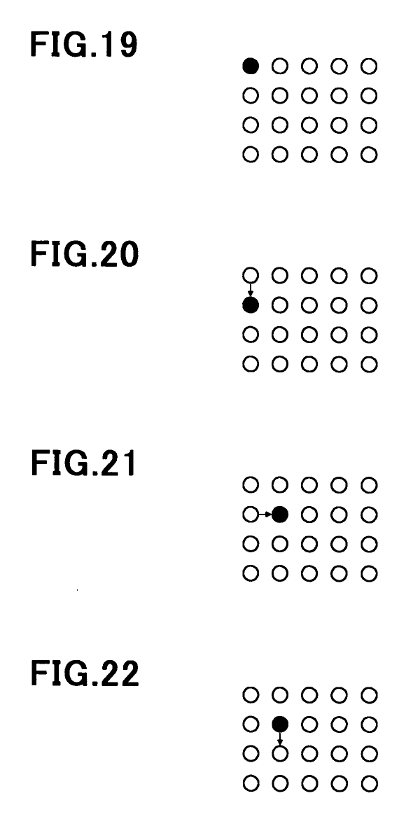

However, if an image is obliquely moved, the image might go dim. Hence, as illustrated in FIGS. 19 to 22, it is preferable that an image is moved first horizontally, and then, vertically, and vice versa.

For instance, when an image is to be moved obliquely, the image is first moved vertically downwardly as illustrated in FIGS. 19 and 20, then, horizontally to the right as illustrated in FIGS. 20 and 21, and then, vertically downwardly as illustrated in FIGS. 21 and 22. By moving an image horizontally and vertically pixel by pixel, it is possible to prevent an image from going dim.

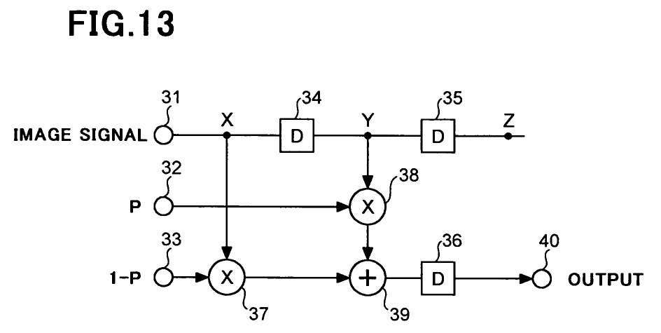

The operation of the apparatuses 100 and 200 may be carried out by means of the logic circuits as illustrated in FIGS. 10 and 13, or by means of a software program, as mentioned earlier.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2005-221421 filed on Jul. 29, 2005 including specification, claims, drawings and summary is incorporated herein by reference in its entirety.

What is claimed is:

1. An apparatus for controlling displaying images to prevent a screen from being burned by moving locations where images are displayed, comprising:
a controller which changes a display level of each of pixels constituting an image into a display level of pixels located around said each of pixels through a plurality of steps, to move a location where said image is displayed such that a distance by which an image moves in a single step is apparently smaller than a pixel,
said controller moving a location at which said image is displayed such that at least one of T1 and T3 is longer than T2,
wherein T1 indicates a length of a first display period in which a display level of said each of pixels is varied by X/3 from an initial display level, T2 indicates a length of a second display period in which said display level of said each of pixels is varied by X/3 from expiration of said first display period, and T3 indicates a length of a third display period in which said display level of said each of pixels is varied by X/3 from expiration of said second display period,
wherein X indicates total alteration of said display level of said each of pixels, caused by moving said image by a pixel.

2. The apparatus as set forth in claim 1, wherein said pixels located around said each of pixels are pixels located adjacent to said each of pixels.

3. The apparatus as set forth in claim 1, wherein said controller moves said image horizontally during a first period of time which is different from a second period of time during which said controller moves said image vertically.

4. The apparatus as set forth in claim 1, wherein said controller includes a step-length controller which varies a length of a time of each of said plurality of steps,
wherein a length of a time in a step in at least one of said first and third display periods is longer than a length of a time in a step in said second display period.

5. An apparatus for controlling displaying images to prevent a screen from being burned by moving locations where images are displayed, comprising:
a controller which changes a display level of each of pixels constituting an image into a display level of pixels located around said each of pixels through a plurality of steps, to move a location where said image is displayed such that a distance by which an image moves in a single step is apparently smaller than a pixel,
said controller comprising:
a synthesizer which synthesizes pixels constituting an image and pixels located around said image-constituting pixels to each other; and
a synthesis-ratio administrator which gradually varies a synthesis ratio in accordance with which said synthesizer synthesizes said pixels to each other,
wherein a rate at which said synthesis ratio varies in at least one of first and second display periods is smaller than a rate at which said synthesis ratio varies in a second display period,
wherein said first display period indicates a period in which T/3 has passed since a display level of each of pixels is an initial display level, said second display period indicates a period in which T/3 has passed since expiration of said first display period, and said third display period indicates a period in which T/3 has passed since expiration of said second display period,
wherein said T indicates a time necessary for moving an image by a pixel.

6. The apparatus as set forth in claim 5, wherein said pixels located around said each of pixels are pixels located adjacent to said each of pixels.

7. The apparatus as set forth in claim 5, wherein said controller includes a movement-controller which varies an apparent movement-distance of an image in each step in said plurality of steps,
wherein an apparent movement-distance of an image in a step in at least one of said first and third display periods is shorter than an apparent movement-distance of an image in a step in said second display period.

8. The apparatus as set forth in claim 5, wherein said controller moves said image horizontally during a first period of time which is different from a second period of time during which said controller moves said image vertically.

9. An apparatus for controlling displaying images to prevent a screen from being burned by moving locations where images are displayed, comprising:
a controller which changes a display level of each of pixels constituting an image into a display level of pixels located around said each of pixels through a plurality of steps, to move a location where said image is displayed such that a distance by which an image moves in a single step is apparently smaller than a pixel,
wherein an apparent average speed of said image at the time before said image moves is different from an average speed of said image at the time when said image moves by a half-pixel.

10. The apparatus as set forth in claim 9, wherein said apparent average speed of said image at the time before said image moves is lower than said average speed of said image at the time when said image moves by a half-pixel.

11. The apparatus as set forth in claim 9, wherein said controller moves said image horizontally during a first period of time which is different from a second period of time during which said controller moves said image vertically.

12. An apparatus for controlling displaying images to prevent a screen from being burned by moving locations where images are displayed, comprising:
a controller which changes a display level of each of pixels constituting an image into a display level of pixels located around said each of pixels through a plurality of steps, to move a location where said image is displayed such that a distance by which an image moves in a single step is apparently smaller than a pixel,
said controller moving a location at which said image is displayed such that a sum of T1 and T4 is longer than a sum of T2 and T3,
wherein T1 indicates a length of a first display period in which a display level of said each of pixels is varied by X/4 from an initial display level, T2 indicates a length of a second display period in which said display level of said each of pixels is varied by X/4 from expiration of said first display period, T3 indicates a length of a third display period in which said display level of said each of pixels is varied by X/4 from expiration of said second display period, and T4 indicates a length of a fourth display period in which said display level of said each of pixels is varied by X/4 from expiration of said third display period,
wherein X indicates total alteration of said display level of said each of pixels, caused by moving said image by a pixel.

13. An apparatus for controlling displaying images to prevent a screen from being burned by moving locations where images are displayed, comprising:
a controller which changes a display level of each of pixels constituting an image into a display level of pixels located around said each of pixels through a plurality of steps, to move a location where said image is displayed such that a distance by which an image moves in a single step is apparently smaller than a pixel,
said controller comprising:
a synthesizer which synthesizes pixels constituting an image and pixels located around said image-constituting pixels to each other; and
a synthesis-ratio administrator which gradually varies a synthesis ratio in accordance with which said synthesizer synthesizes said pixels to each other,
wherein a sum of a rate at which said synthesis ratio varies in a first display period and a rate at which said synthesis ratio varies in a third display period is smaller than a rate at which said synthesis ratio varies in a second display period,
wherein said first display period indicates a period in which T/4 has passed since a display level of each of pixels is an initial display level, said second display period indicates a period in which T/2 has passed since expiration of said first display period, and said third display period indicates a period in which T/4 has passed since expiration of said second display period,
wherein said T indicates a time necessary for moving an image by a pixel.

14. A method of controlling displaying images to prevent a screen from being burned by changing a display level of each of pixels constituting an image into a display level of pixels located around said each of pixels through a plurality of steps, to move a location where said image is displayed such that a distance by which an image moves in a single step is apparently smaller than a pixel,
said method including the steps of:
(a) varying a display level of each of said plurality of pixels by X/3 from an initial display level;
(b) varying said display level of each of said plurality of pixels by X/3 from expiration of said step (a); and
(c) varying said display level of each of said plurality of pixels by X/3 from expiration of said step (b),
wherein X indicates total alteration of said display level of said each of pixels, caused by moving said image by a pixel,
at least one of said steps (a) and (c) being longer in length than said step (b).

15. A method of controlling displaying images to prevent a screen from being burned by changing a display level of each of pixels constituting an image into a display level of pixels located around said each of pixels through a plurality of steps, to move a location where said image is displayed such that a distance by which an image moves in a single step is apparently smaller than a pixel,
said method including the steps of:
(a) varying a display level of each of said plurality of pixels by a period of time T/3 from an initial display level;
(b) varying said display level of each of said plurality of pixels by a period of time T/3 from expiration of said step (a); and
(c) varying said display level of each of said plurality of pixels by a period of time T/3 from expiration of said step (b),
wherein said T indicates a time necessary for moving an image by a pixel,
wherein at least one of an apparent movement-distance of each of said plurality of pixels in said step (a) and an apparent movement-distance of each of said plurality of pixels in said step (c) is shorter than an apparent movement-distance of each of said plurality of pixels in said step (b).

16. A method of controlling displaying images to prevent a screen from being burned by changing a display level of each of pixels constituting an image into a display level of pixels located around said each of pixels through a plurality of steps, to move a location where said image is displayed such that a distance by which an image moves in a single step is apparently smaller than a pixel,
said method including the steps of:
(a) varying a display level of each of said plurality of pixels by a period of time T/3 from an initial display level;
(b) varying said display level of each of said plurality of pixels by a period of time T/3 from expiration of said step (a); and
(c) varying said display level of each of said plurality of pixels by a period of time T/3 from expiration of said step (b),
wherein said T indicates a time necessary for moving an image by a pixel,
wherein a rate at which a synthesis ratio varies in at least one of said steps (a) and (c) is smaller than a rate at which said synthesis ratio varies in said step (b), said synthesis-ratio being defined as a ratio in accordance with which pixels constituting said image are synthesized with pixels locate around said pixels constituting said image.

17. A method of controlling displaying images to prevent a screen from being burned by changing a display level of each of pixels constituting an image into a display level of pixels located around said each of pixels through a plurality of steps, to move a location where said image is displayed such that a distance by which an image moves in a single step is apparently smaller than a pixel,
said method including the step of differentiating an apparent average speed of said image at the time before said image moves from an average speed of said image at the time when said image moves by a half-pixel.

18. The method as set forth in claim 17, wherein said apparent average speed of said image at the time before said image moves is set lower in said step than said average speed of said image at the time when said image moves by a half-pixel.

19. A display unit comprising:
a signal input which receives image signals;
an A/D converter which converts analog image signals received at said signal input into digital image signals;
an apparatus for processing said digital image signals; and
a display device which display images in accordance with said digital image signals received from said apparatus,
said apparatus including a controller which changes a display level of each of pixels constituting an image into a display level of pixels located around said each of pixels through a plurality of steps, to move a location where said image is displayed such that a distance by which an image moves in a single step is apparently smaller than a pixel,
said controller moving a location at which said image is displayed such that at least one of T1 and T3 is longer than T2,
wherein T1 indicates a length of a first display period in which a display level of said each of pixels is varied by X/3 from an initial display level, T2 indicates a length of a second display period in which said display level of said each of pixels is varied by X/3 from expiration of said first display period, and T3 indicates a length of a third display period in which said display level of said each of pixels is varied by X/3 from expiration of said second display period,
wherein X indicates total alteration of said display level of said each of pixels, caused by moving said image by a pixel.

20. A display unit comprising:
a signal input which receives image signals;
an A/D converter which converts analog image signals received at said signal input into digital image signals;
an apparatus for processing said digital image signals; and
a display device which display images in accordance with said digital image signals received from said apparatus,
said apparatus including a controller which changes a display level of each of pixels constituting an image into a display level of pixels located around said each of pixels through a plurality of steps, to move a location where said image is displayed such that a distance by which an image moves in a single step is apparently smaller than a pixel,
said controller comprising:
a synthesizer which synthesizes pixels constituting an image and pixels located around said image-constituting pixels to each other; and
a synthesis-ratio administrator which gradually varies a synthesis ratio in accordance with which said synthesizer synthesizes said pixels to each other,
wherein a rate at which said synthesis ratio varies in at least one of first and second display periods is smaller than a rate at which said synthesis ratio varies in a second display period,
wherein said first display period indicates a period in which T/3 has passed since a display level of each of pixels is an initial display level, said second display period indicates a period in which T/3 has passed since expiration of said first display period, and said third display period indicates a period in which T/3 has passed since expiration of said second display period,
wherein said T indicates a time necessary for moving an image by a pixel.

21. A display unit comprising:
a signal input which receives image signals;
an A/D converter which converts analog image signals received at said signal input into digital image signals;
an apparatus for processing said digital image signals; and
a display device which display images in accordance with said digital image signals received from said apparatus,
said apparatus including a controller which changes a display level of each of pixels constituting an image into a display level of pixels located around said each of pixels through a plurality of steps, to move a location where said image is displayed such that a distance by which an image moves in a single step is apparently smaller than a pixel,
wherein an apparent average speed of said image at the time before said image moves is different from an average speed of said image at the time when said image moves by a half-pixel.

22. A display unit comprising:
a signal input which receives image signals;
an A/D converter which converts analog image signals received at said signal input into digital image signals;
an apparatus for processing said digital image signals; and
a display device which display images in accordance with said digital image signals received from said apparatus,
said apparatus including a controller which changes a display level of each of pixels constituting an image into a display level of pixels located around said each of pixels through a plurality of steps, to move a location where said image is displayed such that a distance by which an image moves in a single step is apparently smaller than a pixel,
said controller moving a location at which said image is displayed such that a sum of T1 and T4 is longer than a sum of T2 and T3,
wherein T1 indicates a length of a first display period in which a display level of said each of pixels is varied by X/4 from an initial display level, T2 indicates a length of a second display period in which said display level of said each of pixels is varied by X/4 from expiration of said first display period, T3 indicates a length of a third display period in which said display level of said each of pixels is varied by X/4 from expiration of said second display period, and T4 indicates a length of a fourth display period in which said display level of said each of pixels is varied by X/4 from expiration of said third display period,
wherein X indicates total alteration of said display level of said each of pixels, caused by moving said image by a pixel.

23. A display unit comprising:
a signal input which receives image signals;
an A/D converter which converts analog image signals received at said signal input into digital image signals;
an apparatus for processing said digital image signals; and
a display device which display images in accordance with said digital image signals received from said apparatus,
said apparatus including a controller which changes a display level of each of pixels constituting an image into a display level of pixels located around said each of pixels through a plurality of steps, to move a location where said image is displayed such that a distance by which an image moves in a single step is apparently smaller than a pixel,
said controller comprising:
a synthesizer which synthesizes pixels constituting an image and pixels located around said image-constituting pixels to each other; and
a synthesis-ratio administrator which gradually varies a synthesis ratio in accordance with which said synthesizer synthesizes said pixels to each other,
wherein a sum of a rate at which said synthesis ratio varies in a first display period and a rate at which said synthesis ratio varies in a third display period is smaller than a rate at which said synthesis ratio varies in a second display period,
wherein said first display period indicates a period in which T/4 has passed since a display level of each of pixels is an initial display level, said second display period indicates a period in which T/2 has passed since expiration of said first display period, and said third display period indicates a period in which T/4 has passed since expiration of said second display period,
wherein said T indicates a time necessary for moving an image by a pixel.
